(19) United States
(12) Patent Application Publication
(10) Pub. No.: US 2024/0419864 A1
(43) Pub. Date: Dec. 19, 2024

(54) TWO-STAGE SEISMIC DESIGN METHOD FOR REPLACEABLE ENERGY DISSIPATION STEEL FRAME JOINT

(71) Applicant: SOUTH CHINA UNIVERSITY OF TECHNOLOGY, Guangzhou (CN)

(72) Inventors: Junxian ZHAO, Guangzhou (CN); Zhiqiu HE, Guangzhou (CN); Yuyuan ZOU, Guangzhou (CN)

(73) Assignee: SOUTH CHINA UNIVERSITY OF TECHNOLOGY, Guangzhou (CN)

(21) Appl. No.: 18/716,942

(22) PCT Filed: Mar. 17, 2023
(86) PCT No.: PCT/CN2023/082362

§ 371 Date: Jun. 6, 2024

(30) Foreign Application Priority Data
Apr. 14, 2022 (CN) 202210390557.5

(51) Int. Cl. G06F 30/20; G06F 30/13; G06F 119/14

(52) U.S. Cl. CPC G06F 30/20; G06F 30/13; G06F 2119/14

(57) ABSTRACT

The present disclosure provides a two-stage seismic design method for a replaceable energy dissipation steel frame joint, comprising: based on a steel frame structure model with rigid connection of beam and column, determining an elastic bending moment distribution of frame beam under effect of vertical load, and determining a preliminary position of the replaceable energy dissipation joint; determining a yield bending moment M_{y} and an ultimate bearing capacity of a buckling-restrained brace of the replaceable energy dissipation joint to design a connection section of the buckling-restrained brace and a length thereof; determining a deformation requirement of the replaceable energy dissipation joint, and determining a lower limit of a length of a yield section of the buckling-restrained brace from the deformation requirement of the joint; determining an elastic axial rigidity requirement of the buckling-restrained brace; determining a bending moment-rotation angle constitutive relation of the replaceable energy dissipation joint.

### BACKGROUND

### Technical Field

The present disclosure relates to the field of seismic design of building structures, and in particular to a two-stage seismic design method for a replaceable energy dissipation steel frame joint based on a rotation mechanism of an upper flange of the beam.

### Description of Related Art

Steel structure has been widely used at domestic and foreign construction industry due to its light weight and high strength, as well as the advantages of assembly and greenization, which is also an important direction for energetically developing Chinese construction industrialization. Steel frame structure is one of the most basic seismic steel structure systems, but the previous earthquake damage shows that the steel frame beam-column joints are prone to brittle fracture due to the existence of welding thermal influence and stress concentration, and the plastic damage of beam end caused by earthquake also brings difficulties to the post-earthquake repair of the structure. How to construct seismic and ductile structure with good seismic performance and recoverability after earthquake has become an important part of seismic and ductile urban construction. The emergence of replaceable steel frame joints provides a possibility for the rapid recovery of the function of the structure after an earthquake. The replaceable energy dissipation joint are formed by placing replaceable energy dissipation members on the beam-column interface or steel beams, converting the deformation between seismic layers of the structure into the rotation angle deformation of the joints, and then converting the rotating deformation into a linear displacement, thereby driving the deformation of the energy dissipation members and dissipating the seismic energy. After the earthquake, the energy dissipation members can be replaced according to the requirements of repair, while the beam-column main structure remains elastic and continues to be used, and the dual objectives of seismic performance and recoverability after the earthquake are taken into account.

With regard to the deformation mechanism of a joint, there are two main deformation modes (as shown in FIG. 1 and FIG. 2, respectively) with a centroid of the beam segment as the rotation center and an upper flange of the beam as the rotation center. As disclosed by Zhao Junxian etc. in the Chinese granted invention patent CN106320517 B, the “replaceable energy dissipation beam-column connection of an upper end suspension steel frame after an earthquake” takes the upper flange of the beam as the rotation center, and the joint has the following advantages.

1) The upward movement of the rotation center of the beam can amplify the deformation requirement of the replaceable energy dissipation member (as Δ₂=2Δ₁ in FIG. 1 and FIG. 2) under the same relative rotation angle of the beam (as θ_{G} in FIG. 1 and FIG. 2), thereby increasing the bending rigidity and energy dissipation capacity of the joint;

2) The upward movement of the rotation center of the beam can effectively release the rotation constraint of the floor slab on top of the beam and reduce the floor cracking caused by the rotation of the joint, which is beneficial to improve the symmetry and stability of the energy consumption curve of the joint and the recoverability of the floor after earthquake;

3) The opening and closing deformation of the joints caused by the rotation mechanism of the cross-sectional centroid of the beam exists at the top and bottom of the beam at the same time wherein it is not easy to set the replaceable energy dissipation member for the top of the beam due to the existence of the floor slab, and the feasibility of the replacement of the member after the earthquake is limited due to the obstruction of the floor. On the contrary, the rotation mechanism of the upper flange of the beam can transfer the opening and closing deformation of the joint to the bottom of the beam, which facilitates the arrangement of the replaceable energy dissipation member and the post-earthquake replacement due to the absence of floor slab obstruction.

In the selection of replaceable energy dissipation members, miniaturized metal, friction, viscous, viscoelastic and other dampers can be used. Among them, metal dampers have stable material properties and easy prediction of mechanical properties, which are the main development direction of replaceable energy dissipation members in the future. In terms of energy dissipation principle, the replaceable energy dissipation member with metal damper can adopt such energy dissipation mechanisms as tension-compression yield, bending yield and shear yield. The tension-compression yield form has the advantages of simple mechanical model, large axial rigidity and sufficient energy dissipation capacity, which can maximize the seismic performance of replaceable energy dissipation member. Therefore, the tension-compression yield metal dampers will have broad application scenarios in recoverable functional structures in the future.

At present, the two-stage design method is adopted in the seismic design of buildings in China, i.e. the elastic internal force analysis of the structure is carried out in the frequent earthquake stage (small earthquakes), and the bearing capacity design of the component is performed in the elastic stage, and the elastic-plastic analysis of the structure and the checking of the story-to-story deformation are carried out in the rare earthquake stage (large earthquakes). For the replaceable steel frame joints based on the rotation mechanism of the flange on the beam, due to the changes in the joint deformation mechanism, internal force transmission mode, energy dissipation mechanism and recoverable mechanism, the design process of the new type of joints does not match the current seismic design methods in China, and there are some outstanding problems, such as the joint rigidity weakening, the joint rotational rigidity and constitutive model being unclear, the coupling of the vertical internal force and the seismic internal force, which seriously hinders the engineering application of the new type of joints. Therefore, according to the unique working mechanism of such joints, a two-stage seismic design method for a replaceable energy dissipation steel frame joint is proposed, which is consistent with the existing seismic design ideas in China, so as to improve the seismic toughness of single building and realize the seismic toughness of city as soon as possible.

### SUMMARY

In order to solve the problems existing in the prior art, the present disclosure proposes a two-stage seismic design method for a replaceable energy dissipation steel frame joint with an upper flange of a beam as a rotation center.

In order to achieve the object of the present disclosure, there is provided a two-stage seismic design method for a replaceable energy dissipation steel frame joint, comprising the following steps:
step 1: determining a bending moment distribution of a frame beam under effect of a vertical load, determining a preliminary position of the replaceable energy dissipation joint on the basis of a zero point of bending moment of the steel frame beam under effect of the vertical load, and allowing a position where a preset offset a is generated to one side of an adjacent column on the basis of the preliminary position to be an actual position of the replaceable energy dissipation joint;
step 2: determining a yield bending moment M_{y} of the replaceable energy dissipation joint and an ultimate bearing capacity of a buckling-restrained brace to design a connection section of the buckling-restrained brace and a length thereof;
step 3: assuming that each section of a beam and a column is a rigid body, according to structural geometric characteristics of the replaceable energy dissipation steel frame joint, determining a relationship among a structural deformation, a rotation angle of the joint and deformation of the buckling-restrained brace, determining deformation requirement of the replaceable energy dissipation joint, and determining a lower limit of a length of a yield section of the buckling-restrained brace according to the deformation requirement of the joint;
step 4: establishing a basic assumption and an analysis method for calculating a rigidity requirement of the replaceable energy dissipation joint, and determining an elastic axial rigidity requirement of the buckling-restrained brace on the basis of the basic assumption and the analysis method, wherein a value of the elastic axial rigidity requirement of the buckling-restrained brace is:

$${K}_{req} = \frac{{EA}_{ave}}{{l}_{B}} = \frac{2 {EI}_{b} ( {l}_{3} + {l}_{4} )}{{h}_{2} ( {h}_{1} + {h}_{2} ) ( {l}_{2} + {l}_{3} + 2 {l}_{4} + d ) {l}_{B}}$$

$${K}_{B , E} = \frac{1}{\frac{1}{{K}_{Be}} + \frac{1}{{K}_{By , E}}} = β {K}_{req}$$

$${K}_{Be} = \frac{{EA}_{Be}}{2 {l}_{Be}}$$

$${K}_{By , E} = \frac{{EA}_{By}}{{l}_{By}}$$

wherein K_{req} is the elastic axial rigidity requirement of the buckling-restrained brace, E is an elastic modulus of the steel. Aₐᵥₑ is an equivalent cross-sectional area of the buckling-restrained brace, l_{B} is an equivalent length of the buckling-restrained brace, l_{b} is a cross-sectional moment of inertia of a cantilever beam segment and a intermediate beam segment, l₂ is a horizontal distance from a center of the connection section of the buckling-restrained brace at one end at a side near the column to a splice opening of an adjacent side thereof, l₃ is a horizontal distance from a center of the connection section of the buckling-restrained brace at one end at a side away from the column to the splice opening of the adjacent side thereof, l₄ is a horizontal distance from the center of the connection section of the buckling-restrained brace at the one end at the side away from the column to a center position of the beam, h₁ is a vertical distance from a center of a shear-resistant connection to an axis of the beam, h₂ is a vertical distance from an axis of the buckling-restrained brace to the axis of the beam, d is a splicing gap between adjacent beam segments at the replaceable energy dissipation joint. K_{B,E} is a calculated value of an elastic axial rigidity of the buckling-restrained brace, K_{Be} is an axial rigidity of the connection section of the buckling-restrained brace, K_{By,E} is an elastic axial rigidity of the yield section of the buckling-restrained brace, β=0.95˜1.05 is an adjustment coefficient for the axial rigidity requirement, l_{Be} is an effective length of the connection section of the buckling-restrained brace, l_{By} is a length of the yield section of the buckling-restrained brace, A_{Be} is a cross-sectional area of the connection section of the buckling-restrained brace, and A_{By} is a cross-sectional area of the yield section of the buckling-restrained brace.
step 5: designing the shear-resistant connection according to requirements of shear force and axial force:
step 6: checking seismic damage control of a beam end; and
step 7: determining the bending moment-rotation angle constitutive relation of the replaceable energy dissipation joint from a yield axial force, an elastic rigidity and a post-yield rigidity of the buckling-restrained brace.

Further, a value of a preset offset a in step 1 does not exceed 20% of the preliminary position.

Further, in step 1, when the preset offset is a, it satisfies that:

$${d}_{off} = {l}_{a 0} - {l}_{ac}$$

d_{off}≤αlα₀
in the formula, d_{off} is an allowable offset of a placement position of the replaceable energy dissipation joint, lₐ₀ is a distance from the zero point of the bending moment of the frame beam of a traditional beam-column rigid connection structure to a column axis under the vertical load, and l_{ac} is a distance from an actual placement position of the replaceable energy dissipation joint to the column axis.

Further, step 2 specifically comprises the following sub-steps:
establishing a structural model and imposing a vertical load and a horizontal seismic load on the structural model;
performing an elastic internal force analysis on the structure at a small earthquake stage under a combined action of a vertical load and a horizontal load, determining the yield moment M_{y} of the replaceable energy dissipation joint and a cross-sectional area of the yield section of the buckling-restrained brace according to a design value of the bending moment M₀ of an actual placement position of the replaceable energy dissipation joint under the small earthquake:

$${M}_{y} = 1.05 ∼ 1.1 {M}_{0}$$

$${F}_{By} = 0.95 ∼ 1.05 {M}_{y} / ( {h}_{1} + {h}_{2} )$$

$${A}_{By} = {F}_{By} / {f}_{By}$$

estimating a cross-sectional area and an ultimate bearing capacity of other sections of the buckling-restrained brace according to the design requirement of the buckling-restrained brace:

A_{Be}=2.5A_{By}

F_{B,max}=ωF_{By}
wherein in the formula, F_{By} is a total yield axial force of the buckling-restrained brace, h₁+h₂ is a vertical height difference between an axis of the buckling-restrained brace and a rotation center of the joint, f_{By} is an average value of a yield strength of the steel at the yield section of the buckling-restrained brace. A_{By} is a total area of a cross section of the yield section of the buckling-restrained brace, F_{B,max} is the ultimate bearing capacity of the anti-buckling support, A_{Be} is a total area of a cross section of the connection section of the buckling-restrained brace, and ω is a strengthening coefficient of the steel at the yield section of the buckling-restrained brace considering a comprehensive influence of strain hardening and friction force; and

determining a quantity of bolts required for the connection section of the buckling-restrained brace according to the ultimate bearing capacity of the buckling-restrained brace, and determining a length of the connection section l_{Be}.

Further, in step 3, a maximum deformation of the replaceable energy dissipation joint is limited to not more than 3%, namely:

$${θ}_{G} = 0.8 θ ( \frac{2 {l}_{ac} + {l}_{b}}{{l}_{b}} )$$

$${Δ}_{B} = {θ}_{G} ( {h}_{1} + {h}_{2} )$$

$${l}_{By} \geq \frac{{Δ}_{B}}{3 \%}$$

$$d = 1.5 {Δ}_{B}$$

wherein θ_{G} is a rotation angle of the rigid body of the replaceable energy dissipation joint, θ is a limit value of an interlayer displacement angle of the structure under a large earthquake taking 2% for a frame structure, l_{ac} is a distance from the replaceable energy dissipation joint to the column axis of the frame, l_{b} is a distance between two replaceable energy dissipation joints arranged on a same frame beam, Δ_{B} is an axial deformation of the buckling-restrained brace; h₁+h₂ is a vertical height difference between an axis of the buckling-restrained brace and the rotation center of the joint, l_{By} is a length of the yield section of the buckling-restrained brace and d is a splicing gap between adjacent beam segments at the replaceable energy dissipation joint.

Further, the basic assumption and analytical method described in step 4 are such that:
the steel frame beam with the replaceable energy dissipation joint is taken out from a range from the beam-column interface to a reverse bending point of the beam under seismic action as an isolator for analysis, in which the beam-column interface is regarded as a fixed connection, and a vertical unit force is acted on the reverse bending point of the beam and is used calculate a vertical deflection f_{N} of the steel beam;
an actual configuration of the replaceable energy dissipation joint with a rotation mechanism of an upper flange of the beam is equivalent to a simplified mechanical model, and contribution of an axial deformation and a flexural rigidity of shear-resistant connection of the upper flange of the beam in a small earthquake elastic stage is ignored, a middle point of the shear-resistant connection is assumed to be hinged, and left and right sides thereof are rigidly connected to the axis of the steel beam via vertical rigid arms respectively, a horizontal spacing between the rigid arms is taken as a gap between the beam segments, an equivalent two-force rod is used to act on a cross-sectional axis of the yield section of the buckling-restrained brace, and a rigid arm is provided to be rigidly connected to the axis of the beam at a connection between a connection section of the buckling-restrained brace and the flange of the beam, the rigid arm is then hinged to the equivalent two-force rod, while solid beam segment is modeled using a beam element with a uniform flexural rigidity at the axis of the beam; and
a traditional steel frame beam with the same cross-section, span, boundary condition and load as the steel frame beam with the replaceable energy dissipation joint is established, and the rigidity requirement of the replaceable energy dissipation joint is determined through an equal vertical deflection under a unit force at the reverse bending point of the beam.

Further, in order to simplify the calculation, when the elastic deformation of the steel frame beam with the replaceable energy dissipation joint is calculated, only a deformation of a segment in a range of a region of the buckling-restrained brace and a region of the shear-resistant connection is considered, the vertical deflection at the reverse bending point of the beam of the segment caused by an axial deformation of a replaceable energy dissipation member is equal to a vertical deflection at the reverse bending point of the beam caused by a difference value of the bending moment in the same segment of the traditional steel frame beam, and an axial elastic rigidity requirement of buckling-restrained brace is determined.

Further, in step 4, a length l_{By} of the yield section of the buckling-restrained brace is continuously adjusted so as to adjust an axial rigidity thereof to match a requirement, and another requirement that a design value of the bending moment of the joint under a vertical load does not exceed 30% of an ultimate flexural bearing capacity of the joint is checked, namely, satisfying:

$$\frac{M}{{M}_{u}} \leq 30 \%$$

$${M}_{u} = 1.1 {F}_{B , max} ( {h}_{1} + {h}_{2} )$$

wherein M is a value of the bending moment of the steel frame beam at a position of the replaceable energy dissipation joint under the vertical load, Mᵤ is the ultimate flexural bearing capacity of the replaceable energy dissipation joint, h₁+h₂ is the vertical height difference between the axis of the buckling-restrained brace and the rotation center of the joint, while F_{B,max} is the ultimate bearing capacity of the buckling-restrained brace.

Further, in step 6, considering a combined effect of the vertical load and seismic action, a plastic hinge at the replaceable energy dissipation steel frame joint is fully developed, and a beam end at the beam-column interface is in an elastic state:

$${M}_{u} + ( {V}_{u} + {V}_{g} ) {l}_{a} \leq {M}_{yb}$$

$${M}_{u} = 1.1 {F}_{B , max} ( {h}_{1} + {h}_{2} )$$

$${V}_{u} = 2 {M}_{u} / {l}_{b}$$

$${V}_{g} = {F}_{g} / 2$$

where Mᵤ is an ultimate flexural bearing capacity of the replaceable energy dissipation joint, Vᵤ is a shear force of the beam due to fully developed plasticity of the replaceable energy dissipation joint under earthquake action. V_{g} is a shear force of the beam generated by the vertical load at the replaceable energy dissipation joint, lₐ is a distance from the replaceable energy dissipation joint to the adjacent beam-column interface, M_{yb} is a yield flexural bearing capacity of the beam end at the beam-column interface, F_{B,max} is the ultimate bearing capacity of the buckling-restrained brace, h₁+h₂ is the vertical height difference between the axis of the buckling-restrained brace and the rotation center of the joint. F_{g} is a vertical force caused by the vertical load borne by the steel frame beam of the replaceable energy dissipation joint, and l_{b} is a length of the intermediate beam segment.

Further, in step 7, the bending moment-rotation angle constitutive relation is:

$${K}_{E} = {{K}_{B , E} ( {h}_{1} + {h}_{2} )}^{2}$$

$${K}_{P} = γ {{K}_{BP} ( {h}_{1} + {h}_{2} )}^{2}$$

$${K}_{B , P} = \frac{1}{\frac{1}{{K}_{Be}} + \frac{1}{{K}_{By , P}}}$$

$${K}_{By , P} = \frac{{E}_{P} {A}_{By}}{{l}_{By}}$$

$${M}_{y} = {f}_{ym} {A}_{By} ( {h}_{1} + {h}_{2} )$$

wherein K_{E} is an elastic rotational rigidity of the replaceable energy dissipation joint. K_{B,E} is a calculated value of the elastic axial rigidity of the buckling-restrained brace, h₁ is a vertical distance from the centroid of the shear-resistant connection to the axis of the beam, h₂ is a vertical distance from the axis of the buckling-restrained brace to the axis of the beam, K_{P} is a post-yield rotational rigidity of the replaceable energy dissipation joint. K_{B,P} is a post-yield axial rigidity of the buckling-restrained brace. K_{By,P} is a post-yield axial rigidity of the yield section of the buckling-restrained brace, γ is an amplification coefficient considering contribution of the flexural bearing capacity of the shear-resistant connection, K_{Be} is an axial rigidity of the connection section of the buckling-restrained brace, E_{P} is a post-yield tangent modulus of the steel of the yield section of the buckling-restrained brace; f_{ym} is an average value of a measured strength of the steel at the yield section of a core plate of the buckling-restrained brace, and A_{By} is a cross-sectional area of the yield section of the buckling-restrained brace.

Advantageous effects achieved by the present disclosure compared with prior art are provided at least as follows.

1) The equivalent rigidity design principle of the traditional rigid connection steel frame beam is proposed, and the elastic rotational rigidity requirement of replaceable energy dissipation joint and the elastic axial rigidity requirement of replaceable energy dissipation member are determined, so that the replaceable steel frame structure and the traditional steel frame structure with the same beam-column section maintain the same elastic rigidity characteristics, and it is ensured that the two structures have the same elastic dynamic characteristics and elastic internal force, so that the two structures share the same structural analysis model in the first stage for the seismic design, and the problems such as the unclear rotational rigidity caused by the rigidity weakening of replaceable energy dissipation joints and the difficulty in structural internal force analysis caused thereby are solved;

2) A simplified prediction method for the bending moment-rotation angle constitutive relation of replaceable energy dissipation joints is proposed, and the calculation methods for the key mechanical parameters of the joints, such as elastic rotational rigidity, yield moment, post-yield rigidity and flexural bearing capacity, are defined. Thus, the second-stage elastic-plastic seismic analysis of the replaceable steel frame structure can be carried out by using the concentrated plastic hinge method defined for the traditional structure in the conventional analysis software and only inputting the bending moment-rotation angle mechanical parameters of the replaceable energy dissipation joints.

### BRIEF DESCRIPTION OF THE DRAWINGS

FIG. 1 is a schematic diagram of a joint deformation pattern with cross-sectional centroid of a beam as a rotation center.

FIG. 2 is a schematic diagram of the joint deformation pattern with an upper flange of the beam as the rotation center.

FIG. 3 (a) is an exploded schematic diagram of a replaceable energy dissipation steel frame joint.

FIG. 3 (b) is an assembled schematic diagram of the replaceable energy dissipation steel frame joint.

FIG. 4 is a schematic diagram of an analysis of an isolator removed from a monolithic structure.

FIG. 5 is a simplified mechanical diagram of the replaceable energy dissipation steel frame joint.

FIG. 6 is a schematic diagram of a deformation of a replaceable steel frame beam.

FIG. 7 is a schematic diagram of a deformation of a traditional steel frame beam.

FIG. 8 is a schematic diagram showing a difference in bending moment between a conventional frame beam and a replaceable frame beam.

FIG. 9 is a schematic diagram of a reverse bending point of the beam under vertical load.

FIG. 10 is a schematic diagram of the bending moment at an actual placement position of replaceable energy dissipation joint.

FIG. 11 is a schematic diagram of a cross section of an inner core of a buckling-restrained brace (1-shaped cross-section).

FIG. 12 is a schematic diagram of a structure-joint deformation relation of a replaceable energy dissipation joint frame.

FIG. 13 is a schematic diagram of the bending moment at a region of the replaceable energy dissipation joint under vertical load.

FIG. 14 is a schematic diagram of the bending moment-rotation angle constitutive relation of the replaceable energy dissipation joint determined by the present disclosure.

FIG. 15 is a schematic flow diagram of a design according to an embodiment of the present disclosure.

FIG. 16 is a schematic diagram of one of the embodiments of the present disclosure.

FIG. 17 is a schematic view of an anti-buckling support core according to one embodiment of the present disclosure.

FIG. 18 is a schematic comparative diagram of a theoretical value with a computer simulated value of the bending moment-rotation angle relation for a replaceable energy dissipation joint according to an embodiment of the present disclosure.

FIG. 19 is a comparative diagram of an elastic anti-lateral rigidity of one of the embodiments of the present disclosure with that of an assembly employing the traditional beam-column welded joint.

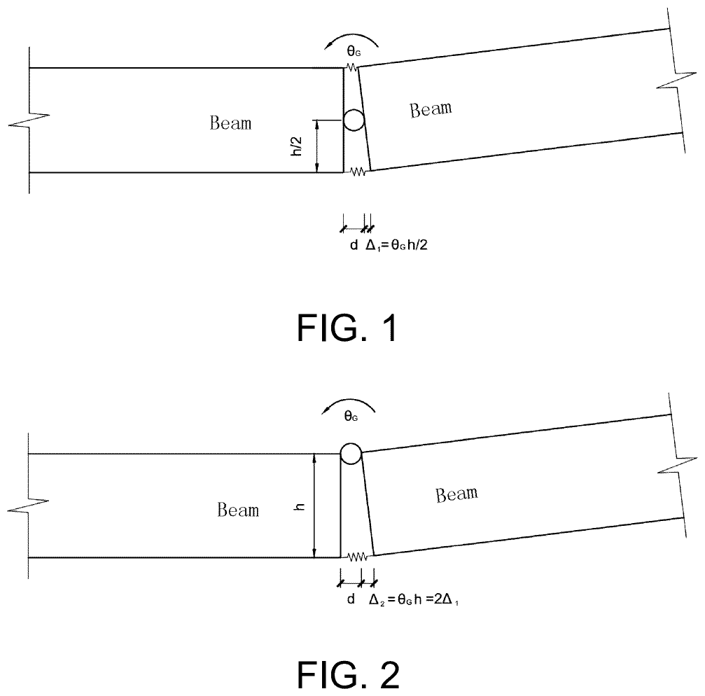

### DESCRIPTION OF THE EMBODIMENTS

These solutions are further described below in conjunction with specific embodiments. It should be understood that these examples are illustrative only and are not intended to limit the scope of the disclosure. The implementation conditions used in the embodiments may be further adjusted according to the conditions of a specific project, and the implementation conditions not specified are generally those in conventional experiments.

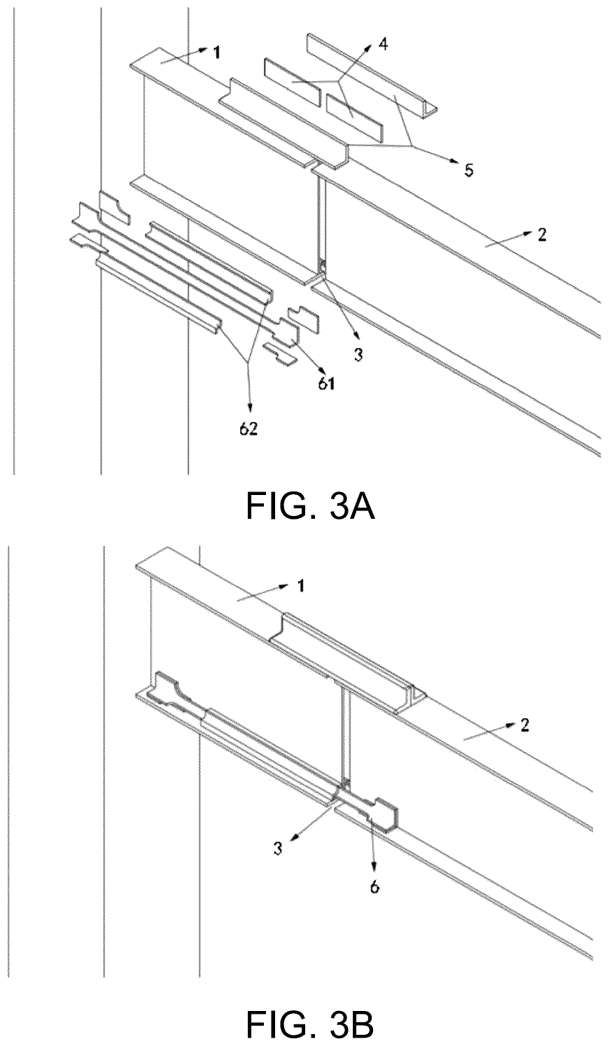

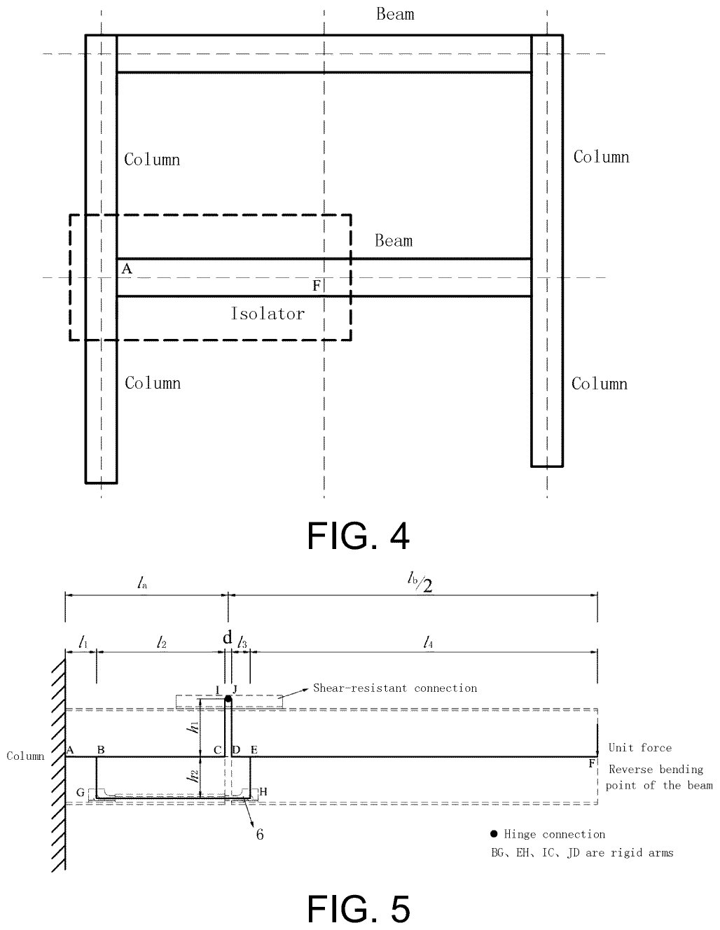

Based on the working principle of the replaceable energy dissipation steel frame joint, a two-stage seismic design method for a replaceable steel frame joint in line with our country's seismic design idea is further proposed. With the upper flange of the beam as the rotation center, a buckling-restrained brace (tensile-compressive yielding metal damper) is installed at the bottom of the beam as a replaceable energy dissipation member. An example of such a joint is given in FIG. 3.

In order to facilitate the calculation of the rigidity requirement of the replaceable energy dissipation joint and the replaceable energy dissipation member, the present disclosure proposes a simplified mechanical diagram of the replaceable steel frame beam as shown in FIG. 5, using the following basic assumptions and analytical method that:
1. the steel frame beam with the replaceable energy dissipation joint (assumed to be a middle point in a length direction of the beam) is taken out from a range from the beam-column interface to a reverse bending point of the beam under seismic action as an isolator for analysis, in which the beam-column interface is regarded as a fixed connection, and a vertical unit force is acted on the reverse bending point of the beam and is used calculate a vertical deflection f_{N} of the steel beam;
2. an actual configuration of the replaceable energy dissipation joint with a rotation mechanism of an upper flange of the beam is equivalent to a simplified mechanical model, and contribution of an axial deformation and a flexural rigidity of shear-resistant connection of the upper flange of the beam in a small earthquake elastic stage is ignored, a middle point of the shear-resistant connection is assumed to be hinged, and left and right sides thereof are rigidly connected to the axis of the steel beam via vertical rigid arms respectively (IC and JD in FIG. 5), a horizontal spacing between the rigid arms is taken as a gap between the beam segments, an equivalent two-force rod (GH in FIG. 5) is used to act on a cross-sectional axis of the yield section of the buckling-restrained brace, and a rigid arm (BG and EH in FIG. 5) is provided to be rigidly connected to the axis of the beam at a connection between a connection section of the buckling-restrained brace and the flange of the beam, the rigid arm is then hinged to the equivalent two-force rod, while solid beam segment is modeled using a beam element with a uniform flexural rigidity at the axis of the beam. An axial rigidity of a shear-resistant member is much greater than a rigidity of the buckling-restrained brace and can be considered infinitely large. The calculation model of replaceable energy dissipation joint can be greatly simplified by moving the rigid arm to a splice opening of the beam segment.

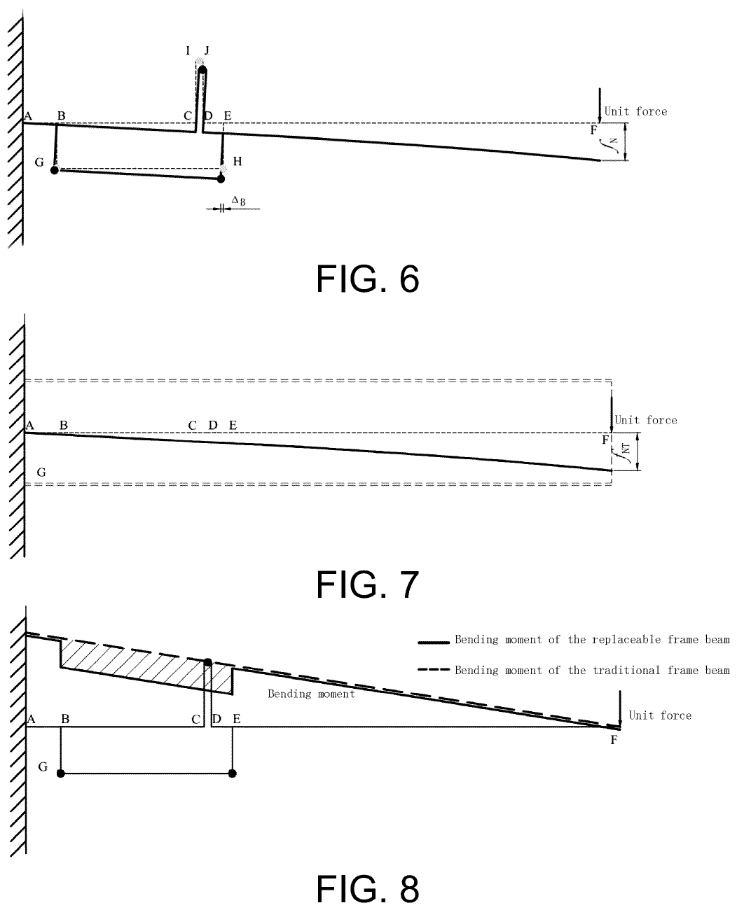

3. A traditional steel frame beam with the same cross section, span, boundary condition and load as the steel frame beam with the replaceable energy dissipation joint (as shown in FIG. 7) is established, the rigidity requirement of the replaceable energy dissipation joint is determined by the fact that the vertical deflection under a unit force acting at the reverse bending point of the beam is equal (namely, f_{N}=f_{NT} see FIG. 6 and FIG. 7). In order to simplify the calculation, it is not necessary to calculate the vertical deflection of the beam end caused by the bending moment in the whole length range of the steel beam. When calculating the elastic deformation of the steel frame beam with the replaceable energy dissipation joint, only the segment deformation in the range of the region of the buckling-restrained brace and a region of the shear-resistant connection (namely, in the range of GH in FIG. 5) is considered. The vertical deflection at the reverse bending point of the beam caused by the axial deformation of the replaceable energy dissipation member in this segment is equal to the vertical deflection at the reverse bending point of the beam caused by the moment difference (see the shaded part of FIG. 8) of the conventional steel frame beam in the same segment (see BE segment in FIG. 7). The axial elastic rigidity requirement of the buckling-restrained brace is determined, and the two-stage seismic design for a replaceable steel frame joint is established based on this rigidity requirement.

The two-stage seismic design method for a replaceable steel frame joint according to the present disclosure is described as follows.

Stage 1: in this stage, an equal rigidity design between the steel beam with the replaceable energy dissipation joint and the traditional steel beam is mainly carried out, which mainly includes 1) a determination of the position of the replaceable energy dissipation joints, 2) a requirement of the yield bending moment of the joint, 3) a requirement of the deformation of the joint, and 4) a determination of the elastic rigidity requirement of the buckling-restrained brace with the above-mentioned requirements as constraints.

Step 1: the position of the replaceable energy dissipation joint is determined. Based on the arrangement of structural members, the three-dimensional model of the structure is established by structural design softwares such as PKPM and YJK according to the conventional beam-column rigid connection, the elastic internal force of each frame beam under vertical load is calculated, and the preliminary position of the replaceable energy dissipation joint is determined according to a zero point of the of the steel frame beam under vertical load.

In this step, the elastic internal force of the frame beam under the vertical load is calculated, and the horizontal seismic load does not participate in the calculation, so that the working performance of the replaceable energy dissipation joint is independent of the vertical load, and therefore the zero position of the bending moment under the vertical load is arranged. After the zero position of the bending moment, the vertical load will not generate the bending moment internal force in the replaceable energy dissipation joint, and therefore the buckling-restrained brace will not generate the axial force at this moment, and thus its working performance is basically independent of the vertical load.

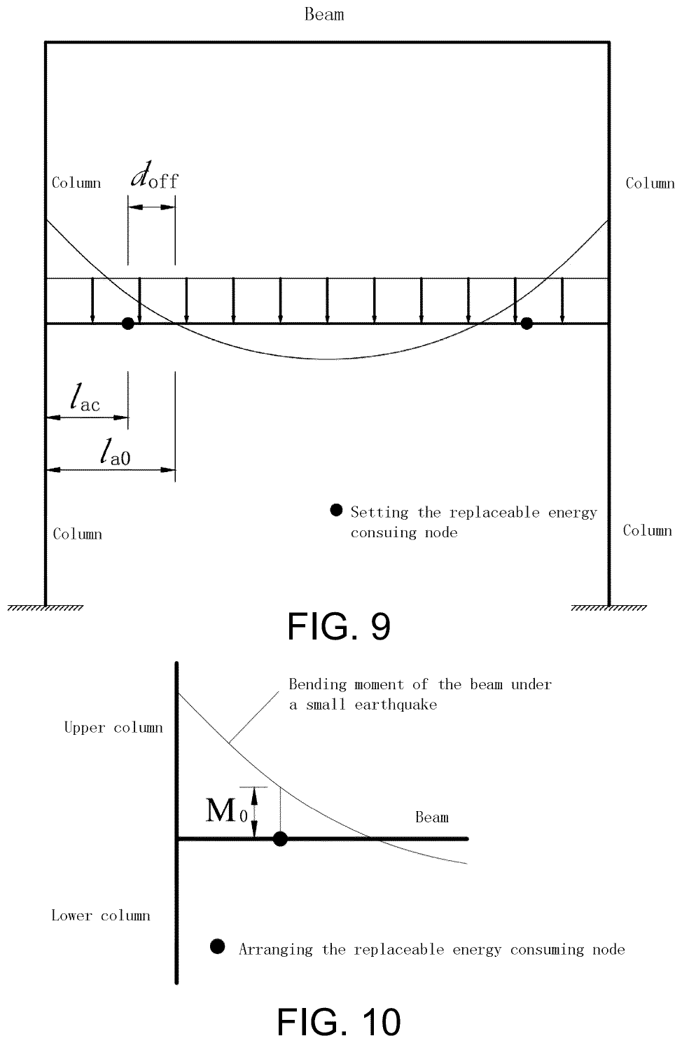

In the present disclosure, the preliminary position of the replaceable energy dissipation joint is determined on the basis of a zero point of bending moment of the steel frame beam under effect of the vertical load, and a position where a preset offset of a is allowed to be generated to one side of an adjacent column on the basis of the position. As shown in FIG. 9, it satisfies that

$${d}_{off} = {l}_{a 0} - {l}_{ac}$$

$${d}_{off} \leq α {l}_{a 0}$$

in the formula, d_{off} is an allowable offset of a placement position of the replaceable energy dissipation joint, lₐ₀ is a distance from the zero point of the bending moment of the frame beam of a traditional beam-column rigid connection structure to a column axis under the vertical load, and l_{ac} is a distance from an actual placement position of the replaceable energy dissipation joint to the column axis.

In some of the embodiments of the present disclosure, the offset a is no more than 20% of the preliminary position. When the offset is less than 20% of the preliminary position, the joint performance is not controlled by the vertical internal force, but mainly depends on the seismic internal force, and the bending moment requirement at the beam end can be reduced to a large extent. The double-objective cooperation between the vertical internal force decoupling and the beam end damage control is realized, which lays an important foundation for giving full play to the joint elastic-plastic deformation capacity under large earthquakes and ensuring the similar seismic performance of the left and right steel beam joints.

Step 2: a yield bending moment M_{y} of the replaceable energy dissipation joint and an ultimate bearing capacity of a buckling-restrained brace are designed to design a connection section of the buckling-restrained brace and a length thereof.

In some of the embodiments of the disclosure, step 2 specifically includes the following steps.

Step 2.1: in the structural design software such as PKPM and YJK, the structural model is established according to the conventional beam-column connection. The structural model is the same as the structural model of step 1, but the types of loads applied to the structure are different. In step 1, only vertical load is applied to the structural model, while vertical load and horizontal seismic load are applied to the structural model.

Step 2.2: an elastic internal force analysis is performed on the structure at a small earthquake stage under a combined action of a vertical load and a horizontal load, the yield moment M_{y} of the replaceable energy dissipation joint and a cross-sectional area of the yield section of the buckling-restrained brace are determined according to a design value of the bending moment M₀ of an actual placement position of the replaceable energy dissipation joint under the small earthquake:

$${M}_{y} = 1.05 ∼ 1.1 {M}_{0}$$

$${F}_{By} = 0.95 ∼ 1.05 {M}_{y} / ( {h}_{1} + {h}_{2} )$$

$${A}_{By} = {F}_{By} / {f}_{By}$$

wherein the yield bending moment of the replaceable energy dissipation joint is 1.05˜1.1 times that of the design value of the bending moment of the joint under earthquake and vertical load, wherein the elastic bearing capacity of the joint under small earthquake can also be considered at the same time of equal rigidity, and the problem of inconsistent rigidity and strength of the replaceable joint can be solved;
a cross-sectional area and an ultimate bearing capacity of other sections of the buckling-restrained brace are estimated according to the design requirement of the buckling-restrained brace:

A_{Be}=2.5A_{By}

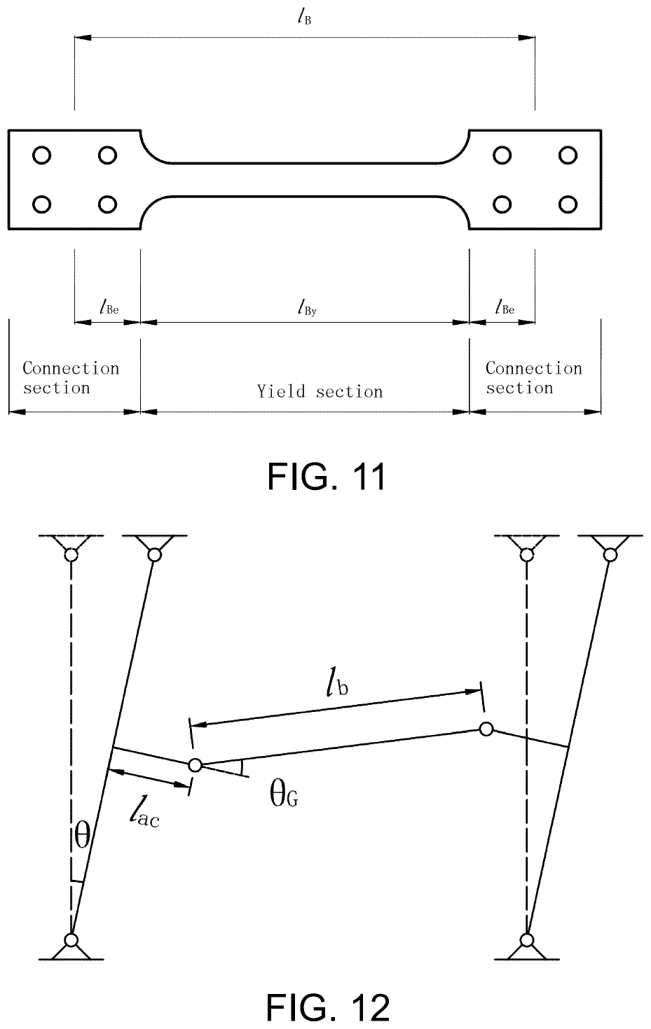

F_{B,max}=ωF_{By}
wherein in the formula, F_{By} is a total yield axial force of the buckling-restrained brace, h₁+h₂ is a vertical height difference between an axis of the buckling-restrained brace and a rotation center of the joint (see FIG. 5), f_{By} is an average value of a yield strength of the steel at the yield section of the buckling-restrained brace, A_{By} is a total area of a cross section of the yield section of the buckling-restrained brace (see FIG. 11), F_{B,max} is the ultimate bearing capacity of the anti-buckling support. A_{Be} is a total area of a cross section of the connection section of the buckling-restrained brace (see FIG. 11), and ω is a strengthening coefficient of the steel at the yield section of the buckling-restrained brace considering a comprehensive influence of strain hardening and friction force; and

Step 2.3: a quantity of bolts required for the connection section of the buckling-restrained brace is determined according to the ultimate bearing capacity of the buckling-restrained brace, and a length of the connection section l_{Be} is determined (see FIG. 11).

Step 3: assuming that each section of a beam and a column is a rigid body, according to structural geometric characteristics of the replaceable energy dissipation steel frame joint (as shown in FIG. 12), a relationship among a structural deformation, a rotation angle of the joint and deformation of the buckling-restrained brace is determined, determining deformation requirement of the replaceable energy dissipation joint, and a lower limit of a length of a yield section of the buckling-restrained brace is determined according to the deformation requirement of the joint.

In some of the embodiments of the present disclosure, to ensure that the buckling-restrained brace has sufficient deformation capability and energy dissipation capability, an axial strain at the yield section of the buckling-restrained brace upon the desired structural deformation should be controlled not to exceed 3%. When the axial strain of buckling-restrained brace is controlled within 3%, better seismic performance and low-cycle fatigue performance can be obtained. It is not easy to break the buckling-restrained brace due to excessive deformation in the earthquake. Since the earthquake is a continuous time process, the buckling-restrained brace should not only endure the maximum deformation generated in the earthquake, but also be able to work continuously during the earthquake without breaking. Therefore, to ensure that the buckling-restrained brace does not break, it is limited to a maximum deformation of not more than 3%, namely:

$${θ}_{G} = 0 \text{.8} θ ( \frac{2 {l}_{ac} + {l}_{b}}{{l}_{b}} )$$

$${Δ}_{B} = {θ}_{G} ( {h}_{1} + {h}_{2} )$$

$${l}_{By} \geq \frac{{Δ}_{B}}{3 \%}$$

$$d = 1. 5 {Δ}_{B}$$

wherein θ_{G} is a rotation angle of the rigid body of the replaceable energy dissipation joint (see FIG. 12), θ is a limit value of an interlayer displacement angle of the structure under a large earthquake taking 2% for a frame structure, l_{ac} is a distance from the replaceable energy dissipation joint to the column axis of the frame (see FIG. 12), l_{B} is a distance between two replaceable energy dissipation joints arranged on a same frame beam (see FIG. 12). Δ_{B} is an axial deformation of the buckling-restrained brace, l_{By} is a length of the yield section of the buckling-restrained brace (see FIG. 11) and d is a splicing gap between adjacent beam segments at the replaceable energy dissipation joint (see FIG. 5).

Step 4: according to the basic assumption and an analysis method for calculating a rigidity requirement of the replaceable energy dissipation joint, the elastic axial rigidity requirement of the buckling-restrained brace is determined. (see FIG. 5 for the calculation model and FIG. 11 for the schematic diagram of the core plate of the buckling-restrained brace)

$${K}_{req} = \frac{{EA}_{ave}}{{l}_{B}} = \frac{2 {EI}_{b} ( {l}_{3} + {l}_{4} )}{{h}_{2} ( {h}_{1} + {h}_{2} ) ( {l}_{2} + {l}_{3} + 2 {l}_{4} + d ) {l}_{B}}$$

$${K}_{B , E} = \frac{1}{\frac{1}{{K}_{Be}} + \frac{1}{{K}_{By , E}}} = β {K}_{req}$$

$${K}_{Be} = \frac{{EA}_{Be}}{2 {l}_{Be}}$$

$${K}_{By , E} = \frac{{EA}_{By}}{{l}_{By}}$$

wherein K_{req} is the elastic axial rigidity requirement of the buckling-restrained brace, E is an elastic modulus of the steel, Aₐᵥₑ is an equivalent cross-sectional area of the buckling-restrained brace, l_{B} is an equivalent length of the buckling-restrained brace, l_{b} is a cross-sectional moment of inertia of a cantilever beam segment and a intermediate beam segment, l₂ is a horizontal distance from a center of the connection section of the buckling-restrained brace at one end at a side near the column to a splice opening of an adjacent side thereof, l₃ a horizontal distance from a center of the connection section of the buckling-restrained brace at one end at a side away from the column to the splice opening of the adjacent side thereof, l₄ is a horizontal distance from the center of the connection section of the buckling-restrained brace at the one end at the side away from the column to a center position of the beam, h₁ is a vertical distance from a center of a shear-resistant connection to an axis of the beam, h₂ is a vertical distance from an axis of the buckling-restrained brace to the axis of the beam, d is a splicing gap between adjacent beam segments at the replaceable energy dissipation joint. K_{B,E} is a calculated value of an elastic axial rigidity of the buckling-restrained brace. K_{Be} is an axial rigidity of the connection section of the buckling-restrained brace, K_{By,E} is an elastic axial rigidity of the yield section of the buckling-restrained brace, β=0.95˜1.05 is an adjustment coefficient for the axial rigidity requirement, l_{Be} is an effective length of the connection section of the buckling-restrained brace, l_{By} is a length of the yield section of the buckling-restrained brace, A_{Be} is a cross-sectional area of the connection section of the buckling-restrained brace, and A_{By} is a cross-sectional area of the yield section of the buckling-restrained brace.

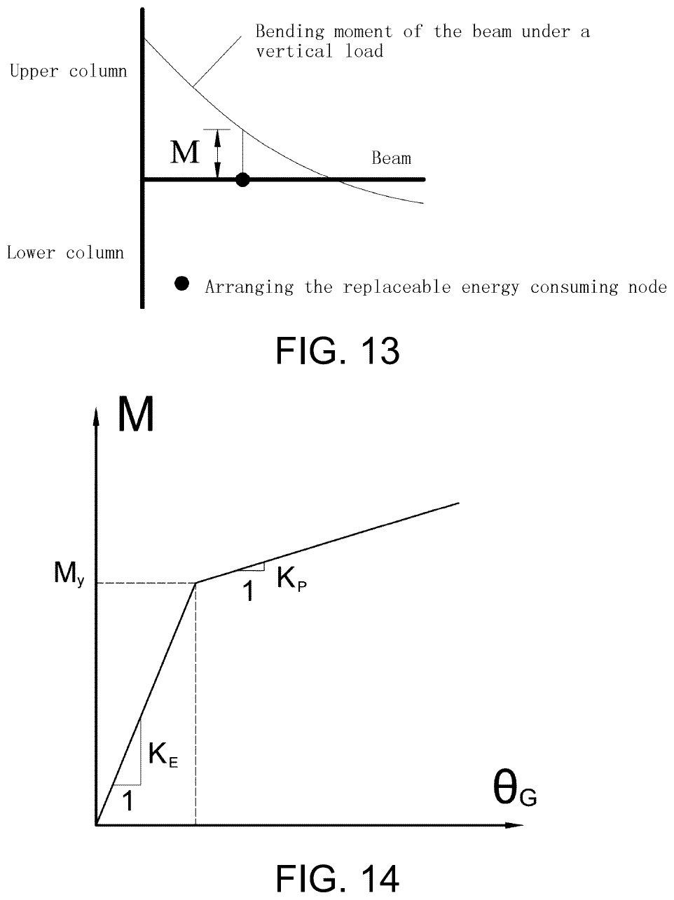

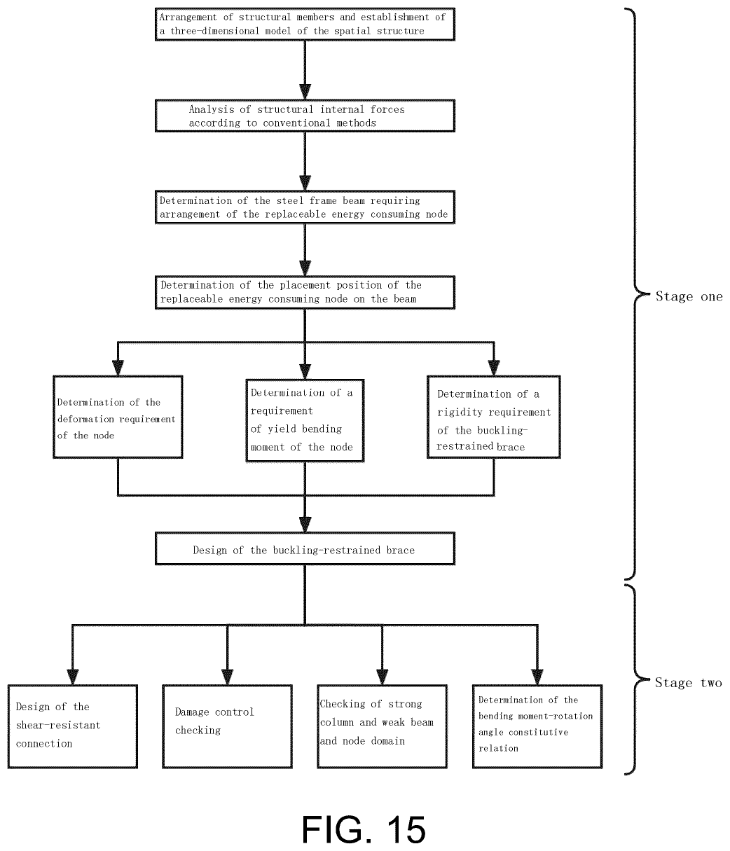

Under the conditions that all the indexes of steps 1-4 are satisfied, the length l_{By} of the yield section of the buckling-restrained brace is continuously adjusted so as to adjust the axial rigidity thereof so as to match the elastic axial rigidity requirement of the buckling-restrained brace, and checking is performed such that the design value of the bending moment of the joint under the vertical load does not exceed the requirement of 30% of the ultimate flexural bearing capacity of the joint, namely, it satisfies that:

$$\frac{M}{{M}_{u}} \leq 30 \%$$

$${M}_{u} = 1.1 {F}_{B , max} ( {h}_{1} + {h}_{2} )$$

wherein M is a value of the bending moment of the steel frame beam at a position of the replaceable energy dissipation joint under the vertical load (see FIG. 13), and M_{,u} is the ultimate flexural bearing capacity of the replaceable energy dissipation joint.

Stage 2: this stage includes two aspects: the seismic damage control design of steel frame beam with the replaceable energy dissipation joint at the large earthquake stage and the bending moment-rotation angle constitutive model of the replaceable energy dissipation joints. The former is used to control the plastic hinge position of steel frame beam at the position of the replaceable energy dissipation joint, and the latter is used to carry out the elastic-plastic analysis of the replaceable steel frame structure in large earthquakes.
step 5: the shear-resistant connection is designed according to requirements of shear force and axial force, including provision of a shear-resistant plate.

In some of the embodiments of the present disclosure, as shown in FIG. 3 (a), the replaceable steel frame joint includes that: a cantilever beam segment 1 (a left beam segment) and an intermediate beam segment 2 (a right beam segment) are disconnected from each other with a gap of an appropriate width, wherein the disconnected position is defined as a fracture 3, one piece of shear-resistant plate 4 (coplanar with a beam web) is welded on the top of the left and right beams near the spliced position, a corner steel 5 overlaps the upper flanges of the left and right beam segments and the shear-resistant plates are connected with each other using a bolt or a weld joint, so that a shear-resistant connection and a rotation center are formed on the upper flanges of the beams, and the left and right ends at the bottom of the beams are respectively connected to lower flanges of the left and right beam segments via buckling-restrained braces. The buckling-restrained brace 6 includes a core plate 61 and a restraint 62 located outside the core plate 61.

Step 6: the seismic damage control of a beam end is checked.

In some of the embodiments of the present disclosure, FIG. 12 shows that the replaceable energy dissipation steel frame joints are symmetrically added in a frame, and the plastic hinges at the replaceable energy dissipation steel frame joints are fully developed and the beam ends at the beam-column interface are in an elastic state considering the combined effects of vertical load and seismic action;

$${M}_{u} + ( {V}_{u} + {V}_{g} ) {l}_{a} \leq {M}_{yb}$$

$${M}_{u} = 1.1 {F}_{B , max} ( {h}_{1} + {h}_{2} )$$

$${V}_{u} = 2 {M}_{u} / {l}_{b}$$

$${V}_{g} = {F}_{g} / 2$$

where Mᵤ is an ultimate flexural bearing capacity of the replaceable energy dissipation joint, Vᵤ is a shear force of the beam due to fully developed plasticity of the replaceable energy dissipation joint under earthquake action, V_{g} is a shear force of the beam generated by the vertical load at the replaceable energy dissipation joint (the shear force of the beam calculated by taking the intermediate beam segment as an equivalent to a simply supported beam), lₐ is a distance from the replaceable energy dissipation joint to the adjacent beam-column interface, M_{yb} is a yield flexural bearing capacity of the beam end at the beam-column interface, F_{B,max} is the ultimate bearing capacity of the buckling-restrained brace, h₁+h₂ is the vertical height difference between the axis of the buckling-restrained brace and the rotation center of the joint (see FIG. 5), F_{g} is a vertical force caused by the vertical load borne by the steel frame beam of the replaceable energy dissipation joint (calculated from the vertical load within the axial length range of the frame beam), and l_{b} is a length of the intermediate beam segment (see FIG. 12).

Step 7: according to the conventional method, a strong column and weak beam and a joint domain of the replaceable energy dissipation steel frame joint are checked.

Step 8: the bending moment-rotation angle constitutive relation of replaceable energy dissipation steel frame joint is determined.

In some embodiments of the present disclosure, the bending moment-rotation angle constitutive relation of the replaceable energy dissipation joint can be determined from the yield axial force, the elastic rigidity and the post-yield rigidity of the buckling-restrained brace in consideration of both the shear-resistant member and the post-yield elastic-plastic working performance of the buckling-restrained brace (see FIG. 14):

$${K}_{E} = {{K}_{B , E} ( {h}_{1} + {h}_{2} )}^{2}$$

$${K}_{P} = γ {{K}_{B , P} ( {h}_{1} + {h}_{2} )}^{2}$$

$${K}_{B , P} = \frac{1}{\frac{1}{{K}_{Be}} + \frac{1}{{K}_{ByP}}}$$

$${K}_{By , P} = \frac{{E}_{P} {A}_{By}}{{l}_{By}}$$

$${M}_{y} = {f}_{ym} {A}_{By} ( {h}_{1} + {h}_{2} )$$

wherein K_{E} is the elastic rotational rigidity of the replaceable energy dissipation joint and K_{P} is the post-yield rotational rigidity of the replaceable energy dissipation joint, K_{B,P} is the post-yield axial rigidity of the buckling-restrained brace, K_{By,P} is the post-yield axial rigidity of the yield section of the buckling-restrained brace, γ is an amplification factor considering the contribution of the flexural bearing capacity of the shear-resistant connection which is taken as 1.1, E_{P} is a post-yield tangent modulus of the steel of the yield section of the buckling-restrained brace which can be taken as 2%-3%, preferably 3% of the elastic modulus, and f_{ym} is an average value of the measured strength of the steel of the yield section of the core plate of the buckling-restrained brace, wherein selected values of the parameters are listed in the Technical Specification for Steel Structures of High-rise Civil Buildings.

In one of the embodiments of the disclosure, a specific example is provided as follows:

The replaceable energy dissipation joint is added to a steel frame, the steel frame uses an H-shaped steel beam and a box-shaped column, and the cross sections and materials of the beam and column are:
Beam: using Q345 steel with cross section of HN500×200×16×10
Column: using Q345 steel with section of □370×370×16×16
Length of the beam column:
Beam: beam length is 6000 mm (calculated as column axis spacing)
Column: column height is 3000 mm (calculated as vertical distance between a midpoint of the upper column and a midpoint of the lower column)
Beam-column joints are rigidly connected by flange welding.

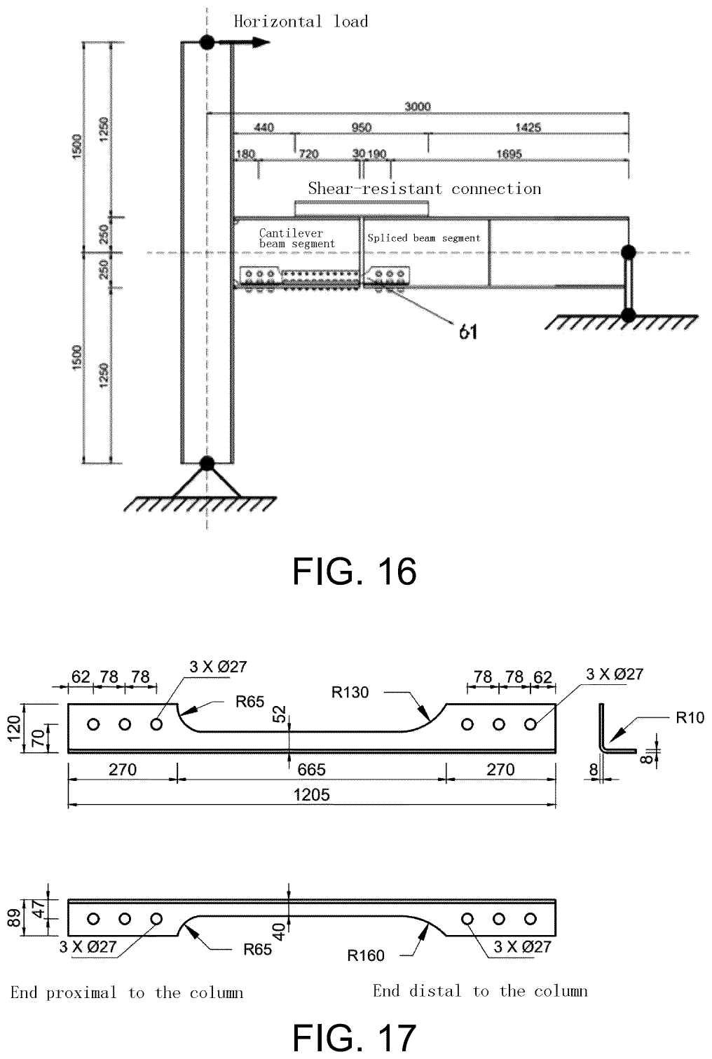

As shown in FIG. 16, the replaceable energy dissipation joint is arranged at a distance of 900 mm from the beam-column interface, the gap between the cantilever beam segment and the intermediate beam segment is 30 mm, the vertical distance from the rotation center of the joint to the axis of the buckling-restrained brace is h₁+h₂=490 mm, and an inner core of the buckling-restrained brace adopts corner steel, with reference to FIG. 17 for the detailed view.

As shown in FIG. 17, the elastic axial rigidity of the buckling-restrained brace can be obtained from the step of stage one:

$${K}_{B , E} = 166.99 KN / mm$$

From the step of the stage two, the post-yield axial rigidity of the buckling-restrained brace can be obtained as follows:

$${K}_{B , P} = 5.08 KN / mm$$

Further, the elastic rotational rigidity of the replaceable energy dissipation joint of the embodiment can be determined from the step st stage two as:

$${K}_{E} = 40094.30 KN \cdot m$$

the post-yield rotational rigidity of the plastic hinge is:

$${K}_{P} = 12 \; 19.71 \cdot m$$

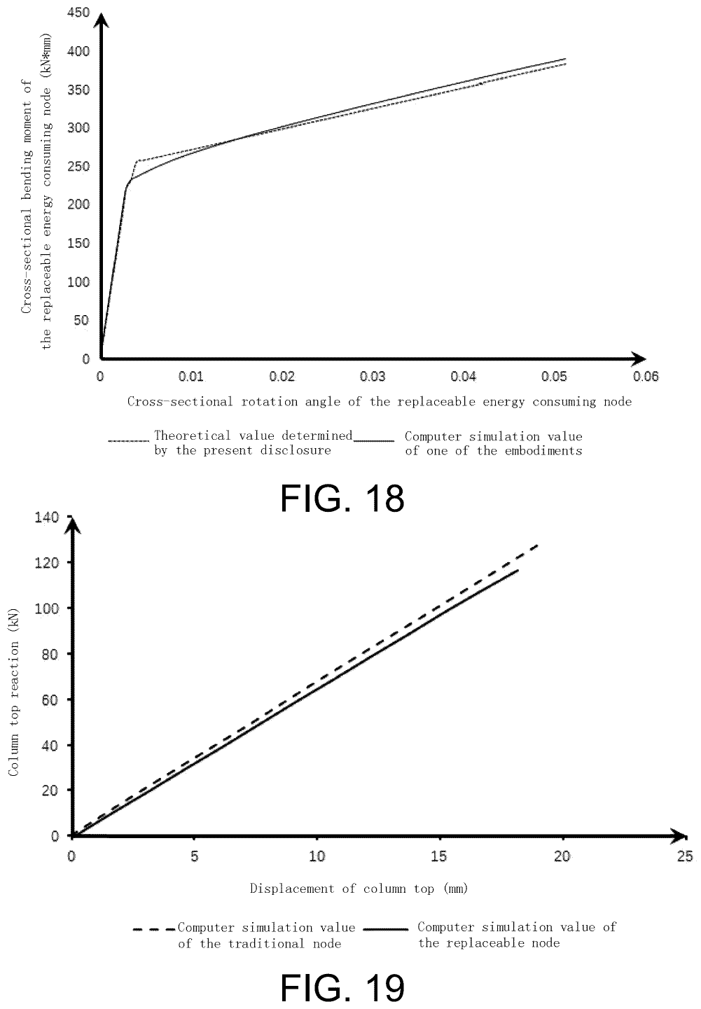

In FIG. 18, the solid line is a graph showing the bending moment-rotation angle relation of the replaceable energy dissipation joint obtained by the computer simulation example of the present embodiment, and the dotted line is a graph showing the bending moment-rotation angle relation of the replaceable energy dissipation joint derived and calculated by the present disclosure which complies with the embodiment. It can be seen from the drawings that the two are basically consistent, and it can be seen that the present disclosure can achieve a simplified prediction of the constitutive relation of the bending moment-rotation angle of a replacement energy consumption joint, which verifies the effectiveness of the present disclosure.

In FIG. 19, the dotted line is a computer simulation curve of the horizontal force-displacement relation of a beam-column assembly using a conventional joint (namely, a beam-column rigid connection); the solid line is a computer simulated graph of the horizontal force-displacement relation of a beam-column combination using the replaceable energy dissipation joint determined by the present disclosure. It can be seen from the figure that the two are basically consistent, and it can be seen that the present disclosure can achieve the design goal of equivalent rigidity with a traditional rigid steel frame beam, which verifies the effectiveness of the present disclosure.

The foregoing has shown and described the basic principles, main features, and advantages of the present disclosure. It will be understood by those skilled in the art that the present disclosure is not limited to the embodiments described above, that the embodiments described above and description in the specification are merely illustrative of the principles of the present disclosure, and that various changes and modifications may be made therein without departing from the spirit and scope of the present disclosure, which fall within the scope of the claimed invention.

1. A two-stage seismic design method for a replaceable energy dissipation steel frame joint, characterized by comprising the following steps:
step 1: determining a bending moment distribution of a frame beam under an effect of a vertical load, determining a preliminary position of a replaceable energy dissipation joint on a basis of a zero point of a bending moment of a steel frame beam under the effect of the vertical load, and allowing a position where a preset offset a is generated to one side of an adjacent column on a basis of the preliminary position to be an actual position of the replaceable energy dissipation joint;
step 2: determining a yield bending moment M_{y} of the replaceable energy dissipation joint and an ultimate bearing capacity of a buckling-restrained brace to design a connection section of the buckling-restrained brace and a length thereof;
step 3: assuming that each of sections of a beam and a column is a rigid body, according to structural geometric characteristics of the replaceable energy dissipation steel frame joint, determining a relationship among a structural deformation, a rotation angle of a joint and a deformation of the buckling-restrained brace, determining a deformation requirement of the replaceable energy dissipation joint, and determining a lower limit of a length of a yield section of the buckling-restrained brace according to the deformation requirement of the joint;
step 4: establishing a basic assumption and an analysis method for calculating a rigidity requirement of the replaceable energy dissipation joint, and determining an elastic axial rigidity requirement of the buckling-restrained brace on a basis of the basic assumption and the analysis method, wherein a value of the elastic axial rigidity requirement of the buckling-restrained brace is:
$${K}_{r e q} = \frac{E {A}_{ave}}{{l}_{B}} = \frac{2 {EI}_{b} ( {l}_{3} + {l}_{4} )}{{h}_{2} ( {h}_{1} + {h}_{2} ) ( {l}_{2} + {l}_{3} + 2 {l}_{4} + d ) {l}_{B}}$$
$${K}_{B , E} = \frac{1}{\frac{1}{{K}_{be}} + \frac{1}{{K}_{B y , E}}} = β {K}_{r e q}$$
$${K}_{B e} = \frac{E {A}_{B e}}{2 {l}_{B e}}$$
$${K}_{By , E} = \frac{E {A}_{B y}}{{l}_{B y}}$$
wherein K_{req} is the elastic axial rigidity requirement of the buckling-restrained brace, E is an elastic modulus of a steel, Aₐᵥₑ is an equivalent cross-sectional area of the buckling-restrained brace, l_{B} is an equivalent length of the buckling-restrained brace, l_{b} is a cross-sectional moment of inertia of a cantilever beam segment and a intermediate beam segment, l₂ is a horizontal distance from a center of the connection section of the buckling-restrained brace at one end at a side near the column to a splice opening of an adjacent side thereof, l₃ is a horizontal distance from a center of the connection section of the buckling-restrained brace at one end at a side away from the column to the splice opening of the adjacent side thereof, l₄ is a horizontal distance from the center of the connection section of the buckling-restrained brace at the one end at the side away from the column to a center position of the beam, h₁ is a vertical distance from a centroid of a shear-resistant connection to an axis of the beam, h₂ is a vertical distance from an axis of the buckling-restrained brace to the axis of the beam, d is a splicing gap between adjacent beam segments at the replaceable energy dissipation joint, K_{B,E} is a calculated value of an elastic axial rigidity of the buckling-restrained brace, K_{Be} is an axial rigidity of the connection section of the buckling-restrained brace, K_{By,E} is an elastic axial rigidity of the yield section of the buckling-restrained brace, β is an adjustment coefficient for the axial rigidity requirement, l_{Be} is an effective length of the connection section of the buckling-restrained brace, l_{By} is a length of the yield section of the buckling-restrained brace, A_{Be} is a cross-sectional area of the connection section of the buckling-restrained brace, and A_{By} is a cross-sectional area of the yield section of the buckling-restrained brace;
step 5: designing the shear-resistant connection according to requirements of shear force and axial force;
step 6: checking seismic damage control of a beam end; and
step 7: determining a bending moment-rotation angle constitutive relation of the replaceable energy dissipation joint from a yield axial force, an elastic rigidity and a post-yield rigidity of the buckling-restrained brace.

2. The two-stage seismic design method for the replaceable energy dissipation steel frame joint according to claim 1, wherein a value of the preset offset a in step 1 does not exceed 20% of the preliminary position.

3. The two-stage seismic design method for the replaceable energy dissipation steel frame joint according to claim 2, wherein in step 1, when the preset offset is a, it satisfies that:
$${d}_{o f f} = {l}_{a 0} - {l}_{a c}$$
$${d}_{o f f} \leq α {l}_{a 0}$$
where d_{off} is an allowable offset of a placement position of the replaceable energy dissipation joint, lₐ₀ is a distance from a zero point of a bending moment of a frame beam of a traditional beam-column rigid connection structure to a column axis under the vertical load, and l_{ac} is a distance from an actual placement position of the replaceable energy dissipation joint to the column axis.

4. The two-stage seismic design method for the replaceable energy dissipation steel frame joint according to claim 1, wherein that step 2 specifically comprises the following steps:
establishing a structural model and imposing a vertical load and a horizontal seismic load on the structural model;
performing an elastic internal force analysis on a structure at a small earthquake stage under a combined action of a vertical load and a horizontal load, determining a yield moment M_{y} of the replaceable energy dissipation joint and a cross-sectional area of the yield section of the buckling-restrained brace according to a design value of a bending moment M₀ of an actual placement position of the replaceable energy dissipation joint under the small earthquake:
$${M}_{y} = 1 \text{.05} ∼ 1.1 {M}_{0}$$
$${F}_{B y} = 0 \text{.95} ∼ 1.05 {M}_{y} / ( {h}_{1} + {h}_{2} )$$
$${A}_{B y} = {F}_{B y} / {f}_{B y}$$
estimating a cross-sectional area and an ultimate bearing capacity of other sections of the buckling-restrained brace according to a design requirement of the buckling-restrained brace:
A_{Be}=2.5A_{By}
F_{B,max}=ωF_{By}
where F_{By} is a total yield axial force of the buckling-restrained brace, h₁+h₂ is a vertical height difference between the axis of the buckling-restrained brace and a rotation center of the joint, f_{By} is an average value of a yield strength of the steel at the yield section of the buckling-restrained brace, A_{By} is a total area of a cross section of the yield section of the buckling-restrained brace, F_{B,max} is an ultimate bearing capacity of an anti-buckling support, A_{Be} is a total area of a cross section of the connection section of the buckling-restrained brace, and ω is a strengthening coefficient of the steel at the yield section of the buckling-restrained brace considering a comprehensive influence of strain hardening and friction force; and
determining a quantity of bolts required for the connection section of the buckling-restrained brace according to the ultimate bearing capacity of the buckling-restrained brace, and determining a length of the connection section l_{Be}.

5. The two-stage seismic design method for the replaceable energy dissipation steel frame joint according to claim 1, wherein in step 3, limiting a maximum deformation of the replaceable energy dissipation joint to be not more than 3%, which means:
$${θ}_{G} = 0.8 θ ( \frac{2 {l}_{a c} + {l}_{b}}{{l}_{b}} )$$
$${Δ}_{B} = {θ}_{G} ( {h}_{1} + {h}_{2} )$$
$${l}_{B y} \geq \frac{{Δ}_{B}}{3 \%}$$
$$d = 1. 5 {Δ}_{B}$$
wherein θ_{G} is a rotation angle of the rigid body of the replaceable energy dissipation joint, θ is a limit value of an interlayer displacement angle of a structure under a major earthquake, l_{ac} is a distance from the replaceable energy dissipation joint to a column axis of a frame, l_{b} is a distance between two replaceable energy dissipation joints arranged on a same frame beam, Δ_{B} is an axial deformation of the buckling-restrained brace; h₁+h₂ is a vertical height difference between the axis of the buckling-restrained brace and a rotation center of the joint, l_{By} is the length of the yield section of the buckling-restrained brace and d is the splicing gap between the adjacent beam segments at the replaceable energy dissipation joint.

6. The two-stage seismic design method for the replaceable energy dissipation steel frame joint according to claim 1, wherein the basic assumption and the analysis method in step 4 are:
the steel frame beam with the replaceable energy dissipation joint is taken out from a range from a beam-column interface to a reverse bending point of the beam under seismic action as an isolator for analysis, in which the beam-column interface is regarded as a fixed connection, and a vertical unit force is acted on the reverse bending point of the beam and is used calculate a vertical deflection f_{N} of a steel beam;
an actual configuration of the replaceable energy dissipation joint with a rotation mechanism of an upper flange of the beam is equivalent to a simplified mechanical model, and contribution of an axial deformation and a flexural rigidity of a shear-resistant connection of the upper flange of the beam in a small earthquake elastic stage is ignored, a middle point of the shear-resistant connection is assumed to be hinged, and left and right sides thereof are rigidly connected to an axis of the steel beam via rigid arms that are vertical respectively, a horizontal spacing between the rigid arms is taken as a gap between beam segments, an equivalent two-force rod is used to act on a cross-sectional axis of the yield section of the buckling-restrained brace, and a rigid arm is provided to be rigidly connected to the axis of the beam at a connection between the connection section of the buckling-restrained brace and a flange of the beam, the rigid arm is then hinged to the equivalent two-force rod, while solid beam segment is modeled using a beam element with a uniform flexural rigidity at the axis of the beam; and
a traditional steel frame beam with a same cross-section, a same span, a same boundary condition and a same load as the steel frame beam with the replaceable energy dissipation joint is established, and the rigidity requirement of the replaceable energy dissipation joint is determined through an equal vertical deflection under a unit force at the reverse bending point of the beam.

7. The two-stage seismic design method for the replaceable energy dissipation steel frame joint according to claim 6, wherein in order to simplify calculation, when an elastic deformation of the steel frame beam with the replaceable energy dissipation joint is calculated, only a deformation of a segment in a range of a region of the buckling-restrained brace and a region of the shear-resistant connection is considered, the vertical deflection at the reverse bending point of the beam of the segment caused by an axial deformation of a replaceable energy dissipation member is equal to a vertical deflection at the reverse bending point of the beam caused by a difference value of a bending moment in a same segment of the traditional steel frame beam, and an axial elastic rigidity requirement of buckling-restrained brace is determined.

8. The two-stage seismic design method for the replaceable energy dissipation steel frame joint according to claim 1, wherein in step 4, the length l_{By} of the yield section of the buckling-restrained brace is continuously adjusted so as to adjust an axial rigidity thereof to match a requirement, and another requirement that a design value of the bending moment of the joint under the vertical load does not exceed 30% of an ultimate flexural bearing capacity of the joint is checked, namely, satisfying:
$$\frac{M}{{M}_{u}} \leq 30 \%$$
$${M}_{u} = 1.1 {F}_{B , max} ( {h}_{1} + {h}_{2} )$$
wherein M is a value of the bending moment of the steel frame beam at a position of the replaceable energy dissipation joint under the vertical load, Mᵤ is the ultimate flexural bearing capacity of the replaceable energy dissipation joint, h₁+h₂ is a vertical height difference between the axis of the buckling-restrained brace and a rotation center of the joint, while F_{B,max} is the ultimate bearing capacity of the buckling-restrained brace.

9. The two-stage seismic design method for the replaceable energy dissipation steel frame joint according to claim 1, wherein in step 6, considering a combined effect of the vertical load and seismic action, a plastic hinge at the replaceable energy dissipation steel frame joint is fully developed, and a beam end at a beam-column interface is in an elastic state:
$${M}_{u} + ( {V}_{u} + {V}_{g} ) {l}_{a} \leq {M}_{y b}$$
$${M}_{u} = 1.1 {F}_{B , max} ( {h}_{1} + {h}_{2} )$$
$${V}_{u} = 2 {M}_{u} / {l}_{b}$$
$${V}_{g} = {F}_{g} / 2$$
wherein Mᵤ is an ultimate flexural bearing capacity of the replaceable energy dissipation joint, Vᵤ is a shear force of the beam due to fully developed plasticity of the replaceable energy dissipation joint under earthquake action, V_{g} is a shear force of the beam generated by the vertical load at the replaceable energy dissipation joint, lₐ is a distance from the replaceable energy dissipation joint to the beam-column interface that is adjacent, M_{yb} is a yield flexural bearing capacity of the beam end at the beam-column interface, F_{B,max} is the ultimate bearing capacity of the buckling-restrained brace, h₁+h₂ is a vertical height difference between the axis of the buckling-restrained brace and a rotation center of the joint, F_{g} is a vertical force caused by the vertical load borne by the steel frame beam of the replaceable energy dissipation joint, and l_{b} is a length of the intermediate beam segment.

10. The two-stage seismic design method for the replaceable energy dissipation steel frame joint according to claim 1, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

11. The two-stage seismic design method for the replaceable energy dissipation steel frame joint according to claim 2, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

12. The two-stage seismic design method for the replaceable energy dissipation steel frame joint according to claim 3, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

13. The two-stage seismic design method for the replaceable energy dissipation steel frame joint according to claim 4, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

14. The two-stage seismic design method for the replaceable energy dissipation steel frame joint according to claim 5, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

15. The two-stage seismic design method for the replaceable energy dissipation steel frame joint according to claim 6, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

16. The two-stage seismic design method for the replaceable energy dissipation steel frame joint according to claim 7, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

17. The two-stage seismic design method for the replaceable energy dissipation steel frame joint according to claim 8, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.

18. The two-stage seismic design method for the replaceable energy dissipation steel frame joint according to claim 9, wherein that the bending moment-rotation angle constitutive relation of step 7 is:
$${K}_{E} = {{K}_{B , E} ( {h}_{1} + {h}_{2} )}^{2}$$
$${K}_{P} = γ {{K}_{B , P} ( {h}_{1} + {h}_{2} )}^{2}$$
$${K}_{B , P} = \frac{1}{\frac{1}{{K}_{Be}} + \frac{1}{{K}_{B y , P}}}$$
$${K}_{By , P} = \frac{{E}_{P} {A}_{B y}}{{l}_{B y}}$$
$${M}_{y} = {f}_{y m} {A}_{B y} ( {h}_{1} + {h}_{2} )$$
wherein K_{E} is an elastic rotational rigidity of the replaceable energy dissipation joint, K_{B,E} is a calculated value of the elastic axial rigidity of the buckling-restrained brace, h₁ is a vertical distance from a rotation center of the joint to the axis of the beam, h₂ is a vertical distance from the axis of the buckling-restrained brace to the axis of the beam, K_{P} is a post-yield rotational rigidity of the replaceable energy dissipation joint, K_{B,P} is a post-yield axial rigidity of the buckling-restrained brace, K_{By,P} is a post-yield axial rigidity of the yield section of the buckling-restrained brace, γ is an amplification coefficient considering contribution of a flexural bearing capacity of the shear-resistant connection, K_{Be} is an axial rigidity of the connection section of the buckling-restrained brace, E_{P} is a post-yield tangent modulus of the steel of the yield section of the buckling-restrained brace, f_{ym} is an average value of a measured strength of the steel at the yield section of a core plate of the buckling-restrained brace, and A_{B}_{_{y}} is the cross-sectional area of the yield section of the buckling-restrained brace.
